(19) United States
(12) Patent Application Publication
(10) Pub. No.: US 2026/0339601 A1
(43) Pub. Date: Oct. 29, 2026

(54) CONTROL METHOD BASED ON MULTI-DIRECTION INPUT DEVICE, MULTI-DIRECTION INPUT DEVICE, CONTROLLER AND INFORMATION PROCESSING SYSTEM

(71) Applicant: SHENZHEN ZESUM TECHNOLOGY CO., LTD, Shenzhen (CN)

(72) Inventors: CHAO-XIAN CHEN, Shenzhen (CN); JUN-HUA TAN, Shenzhen (CN); WEI YANG, Shenzhen (CN); SHI-YING YANG, Shenzhen (CN)

(21) Appl. No.: 19/396,631

(22) Filed: Nov. 21, 2025

(30) Foreign Application Priority Data
Apr. 24, 2025 (CN) 202510521702.2

(51) Int. Cl. G06F 3/16; G06F 3/0338; G06F 3/038; G10L 15/22; G06F 3/0346

(52) U.S. Cl. CPC G06F 3/167; G06F 3/0338; G06F 3/0383; G10L 15/22; G06F 3/0346; G06F 2203/0381; G10L 2015/223

(57) ABSTRACT

Provided in the present application are a control method based on a multi-direction input device, a multi-direction input device, a controller and an information processing system. The control method comprises: receiving control commands, the control commands comprising at least one of operation commands obtained in response to a mechanical operation directed to the multi-direction input device and voice commands captured by the multi-direction input device; generating a control signal based on the control commands and sending the control signal to the terminal device, the control signal configured to control the terminal device to perform target operation, wherein the target operation can comprise at least one of the following operations: a virtual operation in a virtual scene displayed through a graphical user interface provided by the terminal device; a device control operation on the terminal device; and an application function operation implemented using the terminal device.

### CROSS-REFERENCE TO RELATED APPLICATIONS

The present application claims the benefit and priority to Chinese Patent Application Serial No. 202510521702.2, filed on Apr. 24, 2025, in China National Intellectual Property Administration, and the content of which is hereby fully incorporated by reference into the present application.

### FIELD

The present application relates to the technical field of control of multi-direction input devices, specifically to a control method based on a multi-direction input device, a multi-direction input device, a controller and an information processing system.

### BACKGROUND

Currently, a multi-direction input device is a human-computer interaction device that can recognize multi-dimensional user operation inputs (such as push-pull, rotation, pressing, etc.), widely used in industrial machinery control, virtual reality interaction, intelligent home appliance control and other fields. However, in related technologies, users often need to manually operate multi-direction input devices, and one action input intelligently corresponds to one action signal output. When users are unable to perform manual operation or need to output multiple complex operation simultaneously, they cannot achieve multiple operations simultaneously and cannot meet their usage needs. There are situations where users manually operate in a timely and/or inadequate manner, making it difficult to ensure a satisfactory user experience.

Therefore, improvement is desired.

### SUMMARY

In view of the deficiencies of the prior art, the present application provides a control method based on a multi-direction input device, a multi-direction input device, a controller, and an information processing system, the present application can effectively improve the input efficiency of the user and ensure their user experience.

In a first aspect, the embodiments of the present application provide a control method based on a multi-direction input device, the multi-direction input device establishes a communication connection with a terminal device. The control method comprises: receiving control commands, the control commands comprising at least one of operation commands obtained in response to a mechanical operation directed to the multi-direction input device and voice commands captured by the multi-direction input device; generating a control signal based on the control commands and sending the control signal to the terminal device, the control signal configured to control the terminal device to perform the target operation, wherein the target operation can comprise at least one of the following operations: a virtual operation in a virtual scene displayed through a graphical user interface provided by the terminal device; a device control operation on the terminal device; and an application function operation implemented using the terminal device.

In one optional implementation, when the control commands comprise the operation commands and the voice commands, the multi-direction input device generates the control signal according to the control commands comprises:
parsing the voice commands to obtain a corresponding command text;
generating a first control signal when the operation commands match a first operation command combination and the command text comprises a first text, wherein the first control signal is configured to control the terminal device to perform the target operation;
when the control commands satisfy a preset condition and there is a conflict between the voice commands and the operation commands, one of the voice commands or the operation commands is prioritized to be executed in accordance with a preset conflict resolution strategy, and the preset condition comprises that the voice commands does not conform to the first operation command combination and/or that the command text does not comprise the first text.

In one optional implementation, when the control commands comprise the voice commands, the multi-direction input device generates the control signal according to the control commands comprises:
parsing the voice commands to obtain a corresponding command text;
generating a second control signal according to the command text when the command text comprises at least one of a second text or an appointment time; wherein the second control signal is configured to control the terminal device to perform the target operation after the appointment time.

In one optional implementation, when the control commands comprise the voice commands, the multi-direction input device generates the control signal according to the control commands comprises:
parsing the voice commands to obtain a corresponding command text;
generating a third control signal according to the command text when state feedback information is received from the terminal device and the command text comprises a third text; wherein the third control signal is configured to control the terminal device to perform the target operation, and the state feedback information is configured to indicate that the terminal device is in a configuration state.

In one optional implementation, the method further comprises:
obtaining scene feedback information of the terminal device;
outputting first voice information according to the scene feedback information;
wherein the scene feedback information comprises user state information captured by the terminal device, or a frame rate of a video displayed by the terminal device, or scene information captured by the terminal device.

In one optional implementation, the method further comprises:
obtaining historical operation trajectory data and real-time operation trajectory data, and outputting voice information, wherein the historical operation trajectory data comprises the control commands and corresponding target operation occurring during a first preset time period, and the real-time operation trajectory data comprises the control commands and corresponding target operation occurring during a second preset time period, the first preset time period occurs before a current moment and the second preset time period comprises the current moment;
comparing the historical operation trajectory data with the real-time operation trajectory data to obtain a comparison result; and
outputting second voice information based on the comparison result.

In one optional implementation, the method further comprises:
obtaining and saving customized voice commands when the multi-direction input device is in a customized state; wherein the customized voice commands are interrelated with the preset operation commands, and the customized voice commands are configured to perform a target operation corresponding to a preset operation command.

In a second aspect, the embodiments of the present application provide a multi-direction input device, the multi-direction input device comprises an operating member and a voice module, the operating member is used for responding to a mechanical operation of a user to generate operation commands, the voice module is used for capturing the voice commands and executing a control method based on the multi-direction input device of any of the above embodiments.

In a third aspect, the embodiments of the present application provide a controller, the controller comprises the multi-direction input device described above.

In a fourth aspect, the embodiments of the present application provide an information processing system, the information processing system comprises a terminal device and a multi-direction input device described above, and the multi-direction input device establishes a communication connection with the terminal device.

The technical solution of the present application has at least the following technical effects or advantages:

The present application can not only receive operation commands input by users through mechanical operation, but also input via voice, which facilitates contactless input, improves the convenience and efficiency of user input. On another hand, the control method based on a multi-direction input device provided in the present application can meet the simultaneous input of multiple complex operation commands by the user, thereby improving the user experience.

### BRIEF DESCRIPTION OF THE DRAWINGS

In order to more clearly illustrate the technical solutions in the embodiments of the present application, the accompanying drawings to be used in the description of the embodiments will be briefly introduced below, and it will be obvious that the accompanying drawings in the following description are only some of the embodiments of the present application, and that other attachments may be obtained according to these attachments for the person of ordinary skill in the field without paying for the creative laboriousness.

FIG. 1 is a schematic diagram of a multi-direction input device according to one embodiment of the present application.

FIG. 2 is a schematic diagram of an X-axis interface of a multi-direction input device according to one embodiment of the present application.

FIG. 3 is a schematic diagram of a Y-axis interface of a multi-direction input device according to one embodiment of the present application.

FIG. 4 is a block diagram of an information processing system according to one embodiment of the present application.

FIG. 5 is a flowchart of a control method according to one embodiment of the present application.

### DETAILED DESCRIPTION

The present application is described in further detail below in connection with the accompanying drawings and embodiments. The embodiments described below are only a portion of the embodiments of the present application, and not all of the embodiments.

The terminology used in the following embodiments is for the purpose of describing particular embodiments only and is not intended to be a limitation of the present application. As used in the specification and appended claims of this application, the singular expressions "a", "the above", "the" and "this" are intended to include, for example, the expression "one or more" unless the context clearly indicates otherwise. In the following embodiments of the present application, "at least one", "one or more" means one, two or more than two. The term "and/or" is used to describe the relationship between related objects, indicating that there can be three relationships; for example, A and/or B can mean: A exists alone, A and B exist simultaneously, or B exists alone, where A and B can be singular or plural. The character "/" generally indicates that the objects before and after it are in an "or" relationship.

The phrases “in one embodiment,” “in some embodiments,” “in other embodiments,” “in still other embodiments,” etc., appearing in different parts of this specification do not necessarily refer to the same embodiment, but rather mean “one or more, but not all, embodiments,” unless otherwise specifically emphasized. The terms “including,” “comprising,” “having,” and variations thereof all mean “including but not limited to,” unless otherwise specifically emphasized.

Multi direction input device is a human-computer interaction device that can recognize multi-dimensional user operation inputs (such as push-pull, rotation, pressing, etc.), widely used in industrial machinery control, virtual reality interaction, intelligent home appliance control and other fields. However, in related technologies, users often need to manually operate multi-direction input devices, and one action input intelligently corresponds to one action signal output. When users are unable to perform the manual operation or need to output multiple complex operations simultaneously, they cannot achieve multiple operations simultaneously and cannot meet their usage needs. There are situations where users manually operate in a timely and/or inadequate manner, making it difficult to ensure a satisfactory user experience.

To solve these problems, the present application provides a control method based on a multi-direction input device, a multi-direction input device, a controller, and an information processing system, the present application can effectively improve the input efficiency of users and ensure their user experience.

Next, a further introduction will be made to the control method based on a multi-direction input device, the multi-direction input device, the controller and the information processing system provided by the embodiments of the present application.

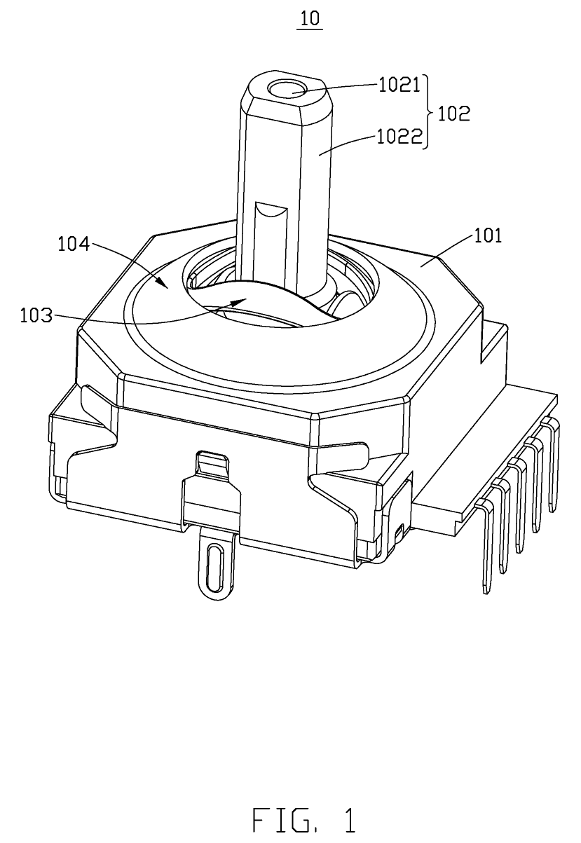

FIG. 1 illustrates a multi-direction input device 10 in accordance with an embodiment of the present application.

The multi-direction input device 10 can include a housing 101 and an operating member 102. The housing 101 defines an accommodating cavity 103, and the housing 101 also defines a first opening 104 that communicates with the accommodating cavity 103. The operating member 102 includes a button portion 1021 and a main body 1022, the main body 1022 is at least partially swingable disposed within the accommodating cavity 103 through the first opening 104, and the button portion 1021 is disposed at the end of the main body 1022 away from the accommodating cavity 103. The user operates by contacting the button portion 1021, and the button portion 1021 drives the main body 1022 so as to realize the operation control in the direction of X-axis, Y-axis and Z-axis.

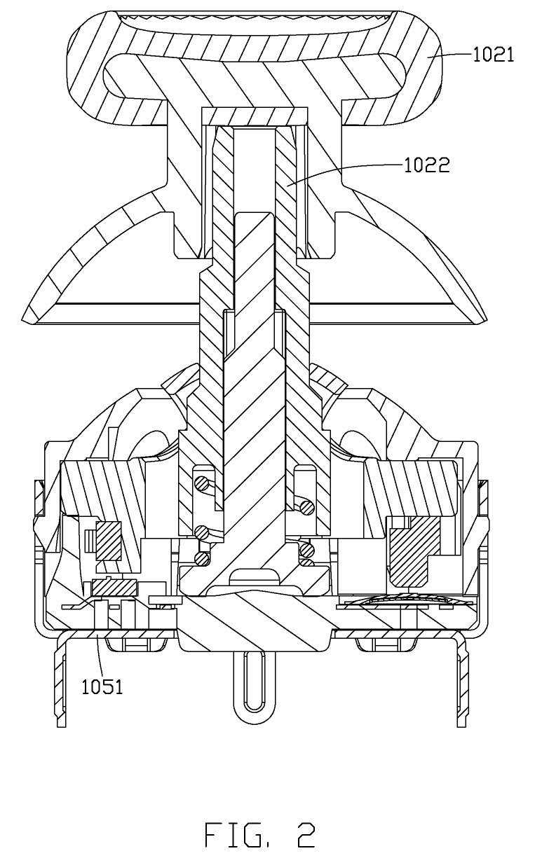

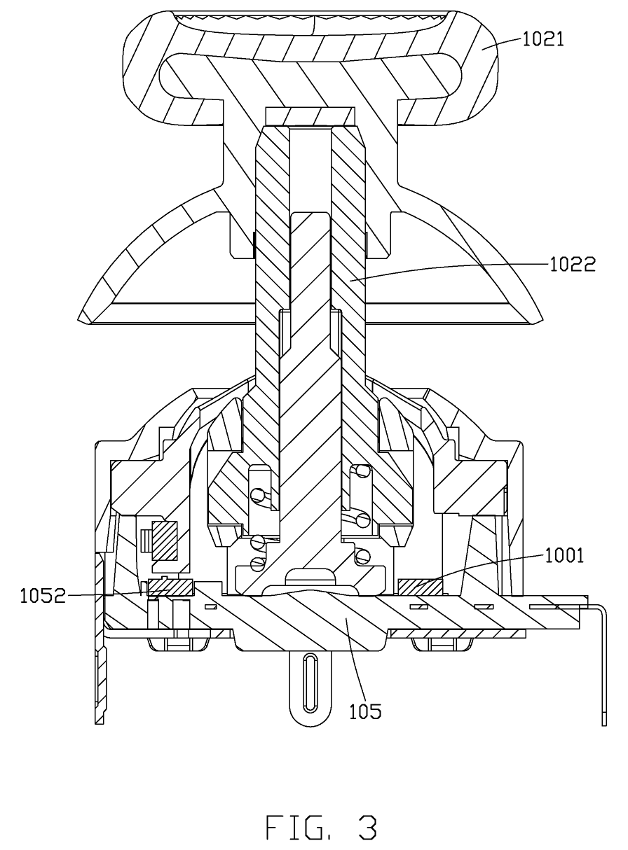

In one embodiment, as shown in FIGS. 2 and 3, the multi-direction input device 10 further includes a circuit board 105, the circuit board 105 is disposed in the accommodating cavity 103, and the circuit board 105 is provided with a number of sensors, such as an X-axis sensor 1051 and a Y-axis sensor 1052. The present application does not limit the specific number of sensors provided on the circuit board 105, and the person skilled in the art may select them according to the actual situation of the multi-direction input device 10. In some embodiments, the circuit board 105 is further provided with a processor 1001 for analyzing and processing the collected data. The processor 1001 is integrated with a voice module, and the voice module has functions such as voice acquisition, natural language processing, and dialog management.

The multi-direction input device 10 of the present application can be shaken and pressed by a joystick to achieve tilting in any horizontal direction and flexible operation in the Z-axis direction, such as a game console joystick, a drone manipulation joystick, or a mobile robot manipulation joystick. The joysticks are typically single-axis, dual-axis, triple-axis, or quad-axis, and a single-axis joystick indicates that it can move between two points in a linear direction (i.e., horizontally or vertically); a dual-axis joystick indicates that it can move in two linear directions (i.e., horizontal and vertical) at four points; a triple-axis joystick indicates that it can move in directions perpendicular to the horizontal and vertical planes outside of the dual axes, represented by the X, Y, and Z axes respectively; a quad-axis joystick indicates that it adds a rotation axis to the triple-axis joystick, the present application does not limit the specific style of the multi-direction input device or the specific object it manipulates.

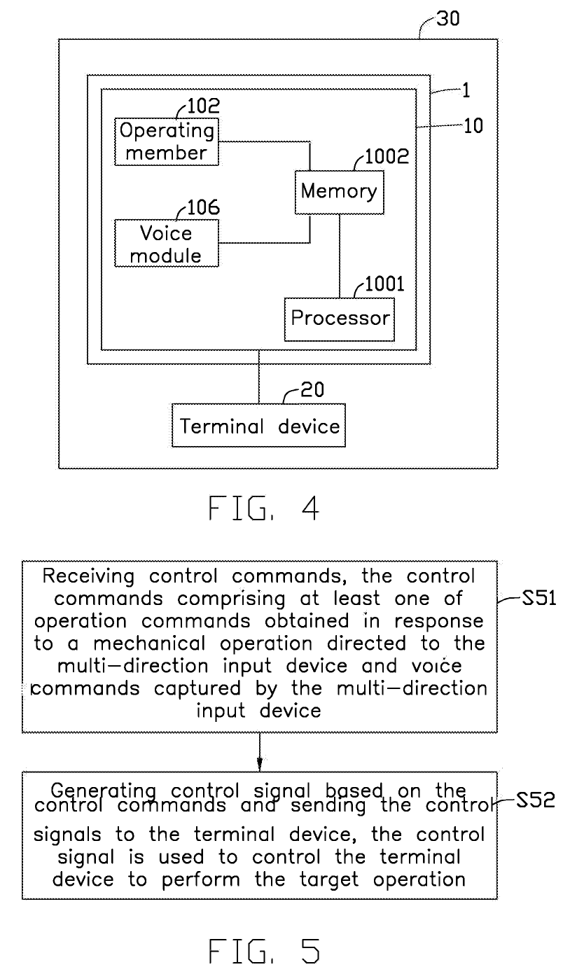

Referring to FIG. 4, in other embodiments, the voice module 106 can also be set independently from the processor 1001, and the present application does not limit this. In some embodiments, the multi-direction input device 10 further includes a memory 1002 for storing computer programs and data. The multi-direction input device 10 also establishes a communication connection with a terminal device 20. The communication connection method can be a wired communication method, such as wired communication based on an RS485 bus; or a wireless communication method, such as Bluetooth, Wi-Fi, ZigBee, and other wireless communication methods, the present application does not limit the specific manner in which the communication connection is established. Therefore, by manipulating the multi-direction input device 10, the user can drive the terminal device 20 communicatively connected to the multi-direction input device 10 to perform in accordance with the manipulation commands of the user, thereby improving the efficiency of the terminal device 20 in performing the operation.

In some embodiments, the multi-direction input device 10 and the terminal device 20 can be two electronic devices that are separately and independently located. In other embodiments, the multi-direction input device 10 can also be directly integrated on the terminal device 20, for example, the terminal device 20 can be a handheld gaming console, in which case the processor 1001 of the multi-direction input device 10 can be integrated on the same processor as the processor (not shown in FIG. 4) of the terminal device 20.

FIG. 5 illustrates a flowchart of a control method based on a multi-direction input device provided in an embodiment of the present application. The control method provided by the present application can be performed by a processor of a multi-direction input device, such as the processor 1001 of FIG. 3. As shown in FIG. 5, the method can include step S51 and step S52 as follows:

At step S51, receiving control commands, the control commands comprising at least one of operation commands obtained in response to a mechanical operation directed to the multi-direction input device and voice commands captured by the multi-direction input device.

Exemplarily, the control commands are used to characterize relevant command signals received by the multi-direction input device 10 during operation, and the control commands can be collected by a number of sensors. For example, as shown in FIGS. 2 and 3, the control commands can include operation commands for movement in the X-axis direction (i.e., in the lateral direction) received via the X-axis sensor 1051, operation commands for movement in the Y-axis direction (i.e., in the longitudinal direction) received via the Y-axis sensor 1052, and operation commands for operation of the operating member 102 in the Z-axis direction. The operation commands can be electrical signals obtained based on sensors or buttons.

The control commands can also include voice commands received via a voice module on the multi-direction input device 10. For example, the voice module can continuously listen for sounds from the environment in which the multi-direction input device 10 is located to receive voice commands. The voice commands can be sound signals captured by the voice module.

The control commands can also be captured in other ways, and the present application does not limit the specific ways in which the control commands can be captured.

Exemplarily, when the control commands are received, the received control commands need to be parsed to obtain the target information. As the multi-direction input device is in operation, there is a situation in which interference information is received while multiple complex commands are received, for example, the ambient sound can cause errors when voice commands are received. Therefore, the corresponding target information is obtained according to the analysis of the control commands, and real and effective commands can be obtained more accurately, so that the terminal device can carry out an accurate display and reduce the probability of executing erroneous commands.

At step S52, generating a control signal based on the control commands and sending the control signal to the terminal device, the control signal is used to control the terminal device to perform the target operation.

The multi-direction input device can generate the control signal based on the control commands and send it to the terminal device, causing the terminal device to perform a target operation based on the received control signal.

The target operation in step S52 can include at least one of the following operations:
a virtual operation in a virtual scene displayed through a graphical user interface provided by a terminal device;
a device control operation on the terminal device;
an application function operation implemented using the terminal device.

For example, when the terminal device is a virtual reality device, a gaming device, or other device that can display virtual scenes, the virtual operation can include controlling characters in the virtual scene to perform actions, controlling screen changes in the virtual scene.

The device control operation can include setting operation on the terminal device, such as setting sound or screen brightness. The setting operation can also include setting the virtual scene displayed on the terminal device, such as game settings.

The application function operation can include controlling the terminal device to start, shut down, pause, send text messages, make phone calls, and play music. The function operation can also include using the terminal device to control other devices, such as starting, pausing, or shutting down the device, or performing other similar operation such as sending text messages, making phone calls, playing music, and the present application does not limit the specifics of the target operation.

In summary, the present application provides a control method based on a multi-direction input device, which generates a control signal to control a terminal device by receiving at least one of the operation commands and the voice commands, realizes non-contact input by a user, and can satisfy the simultaneous input of commands for a variety of complex operations by a user, improves the degree of convenience of input by a user, improves the input efficiency of a user, and improves the experience of the user.

In one embodiment of the present application, when the control commands include the operation commands and the voice commands, generating the control signal according to the control commands in step S52 can include step S101 and step S102 as follows.

At step S101, parsing the voice commands to obtain a corresponding command text.

In some embodiments, a voice parsing model can be obtained to parse the voice commands based on the voice parsing model to obtain corresponding command text. The voice parsing model is a technology that combines voice recognition, natural language processing (NLP) and data analytics, and its core role is to transform voice signals into structured information and extract valuable content from them. In one embodiment of the present application, the voice parsing model can be integrated in a voice module, or the voice commands can be processed by setting up a separate processor loaded with the voice parsing model. In relevant scenarios, such as scenarios in which outputs for multiple complex operations need to be satisfied at the same time or scenarios in which the user does not have access to a multi-direction input device, voice commands enable the extraction of the user's intent after the extraction of the command text.

For example, the voice parsing model can be a statistical voice model or a neural network voice model, and the voice commands are input into the voice parsing model to convert the voice commands into command text. In some embodiments, the voice parsing model can also perform context tracking, recognize the user's voice patterns and emotions, etc., based on historical data, in order to perform voice interaction with the user based on the voice commands. The present application does not limit the specific implemented functions of the voice parsing model. The processor in the multi-direction input device can also save the transformed command text to obtain reference context data, and the reference context data includes, but is not limited to, user intent included in voice commands and historical dialog context. As a result, the multi-direction input device is able to better understand the user's semantics and generate a more tailored dialog strategy, thereby providing the user with a coherent and natural dialog experience. At the same time, in the process of interactive dialog, the interactive data is recorded and saved, expanding the effective range of voice interaction and guaranteeing the real-time dialog of the multi-direction input device.

At step S102, generating a first control signal when the operation commands match the first operation command combination and the command text includes the first text, and the first control signal is used to control the terminal device to perform the target operation.

The first operation command combination represents a preset operation command combination, such as pressing the multi-direction input device twice consecutively or pressing the multi-direction input device for a duration reaching a time threshold. The first text represents a preset text keyword. When a user mechanically operates a multi-direction input device, there is a situation in which a number of complex operations need to be completed simultaneously to control the terminal to perform the target operation, and when the number of operations that need to be completed simultaneously exceeds the number of mechanical operations that can be detected by the sensors in the multi-direction input device, it is necessary to realize the complex operation with the assistance of voice input. In the embodiment, a current compliance with a predetermined complex operation scenario is determined by confirming whether the operation command complies with the predetermined first operation command combination, and whether the command text includes the first text. When the first operation commands match the first operation command combination, and the command text includes the first text, it satisfies the preset complex operation scenario, and at this time, it can be combined with the operation commands and voice commands to assist the user in completing the complex operation, and it can effectively satisfy the user's use requirements.

For example, when the terminal device is a gaming device, by executing steps S101 to S102, multiple complex operations of the user can be realized in a short time, such as the game character needs to perform multiple complex actions in the virtual scene at the same time or needs to open the virtual device panel to replace the virtual device in the process of moving, and due to the different speeds of the user's hand operation, there are cases where the user is unable to complete the action quickly or select the wrong virtual device to change, which may lead to game errors. By executing steps S101 to S102, the user can change the virtual device in the game by voice while performing manual operation, which reduces the probability of the user opening the virtual device panel and reduces the probability of the user having an operation error.

In one embodiment of the present application, when the control commands satisfy a preset condition and there is a conflict between the voice commands and the operation commands, one of the voice commands or the operation commands is prioritized to be executed in accordance with a preset conflict resolution strategy, and the preset condition includes that the voice command does not conform to the first operation command combination and/or that the command text does not include the first text. The conflict resolution strategy can be a preset prioritization algorithm. There is a situation in which the user makes a mistake in the expression of voice commands or a mistake in the operation of the hand that results in an error in the operation commands during the operation process, for example, when the terminal device is a gaming device, the user gives voice commands to the game character to move to the left, but the user pushes the multi-direction input device to the right, and at this time, the conflict resolution strategy is invoked to wire the execution of the voice commands or the mechanical operation commands for the current real-time scenario. Therefore, it can effectively reduce the operation error caused by the user's expression error or mis-touch and improve the user's experience.

In one embodiment of the present application, the operation commands captured after the user mechanically operates the multi-direction input device can also be filtered and analyzed to obtain accurate operation commands before determining whether the operation commands conform to the first operation command combination. After obtaining the operating commands, the mechanical analysis model can be obtained to filter and analyze the operating commands to filter out some of the interfering signals. The mechanical analysis model is used to simulate and analyze the structure of the multi-direction input device, the movement of the operating member and the forces on the operating member. For example, based on the operating habits of a specified user, an implementation record can be made of the force that the operating member is subjected to by the user and a mechanical analysis model can be obtained by training based on the data obtained from the record. Therefore, when the operation commands are input into the mechanical analysis model, accurate operation commands can be obtained, this effectively reduces the generation of interference commands caused by accidental user touches, ensuring the stable operation of the multi-direction input device.

In one embodiment of the present application, when the control commands include the voice commands, the multi-direction input device in step S52 generating the control signal based on the control commands can include:
parsing the voice commands to obtain a corresponding command text.

When the command text includes at least one of a second text or an appointment time, a second control signal is generated based on the command text, and the second control signal is used to control the terminal device to perform the target operation after the appointment time.

The process of parsing the voice commands is substantially the same as in step S101 and is not repeated herein.

The second text is used to indicate a user intent text for performing an operation in a predetermined scenario.

The predetermined scenario can be represented by the terminal device state, position coordinates and contextualized data, and the present application does not limit the specific content of the second text. There are three cases in which the user causes the terminal device to perform the target operation after an appointment time by the inputted voice commands: (a) the voice commands contain only a second text, such as moving along a transverse direction when the virtual character displayed by the graphical user interface reaches the position A; (b) the voice commands contain only the appointment time, for example, moving along a transverse direction after 5s; and (c) the voice commands contain both the second text and the appointment time, for example moving along the transverse direction after 5s and moving along the longitudinal direction when the position A is reached. Therefore, the voice commands can facilitate the user's planning in advance, reduce the probability of errors arising from distracted operation, and reduce the complexity of the operation, which improves the user's operational efficiency and enhances the user's experience.

In one embodiment of the present application, when the control commands include the voice commands, the multi-direction input device in step S52 generating a control signal based on the control commands can include:
parsing the voice commands to obtain a corresponding command text.

When state feedback information is received from the terminal device and the command text includes a third text, a third control signal is generated according to the command text, and the third control signal is used to control the terminal device to perform the target operation. wherein the state feedback information is used to indicate that the terminal device is in a configuration state.

The process of parsing the voice commands is substantially the same as in step S101 and is not repeated herein.

In some embodiments, after the multi-direction input device establishes a communication connection with the terminal device, the terminal device can also periodically feedback the state information to the multi-direction input device. The preset state can include a configuration state or a preset scene state. The configuration state can be used to indicate that the terminal device is in a configurable state. For example, in the initial period after the terminal device is started, it can enter the configuration state to make personalized settings (e.g., sound settings, screen display settings, game settings, etc.) to meet the user's personalized needs. The preset scene state is used to indicate that the terminal device is currently in a preset scene.

The third text is used to indicate the target operation that need to be repeated and/or operation that need to be performed consecutively in a short period of time.

For example, after the terminal device is started, when it is confirmed that the terminal device is in a configuration state by the state feedback information and the command text includes a third text, the setting operation at the initial stage of the startup of the terminal device can be accomplished by the voice commands. Therefore, compared to completing the setup through mechanical operation, it can effectively improve the operation efficiency and enhance the user experience.

For example, when the same operation needs to be performed in multiple locations, and it takes a long time for the user to perform the operation mechanically, voice commands can be used to execute the corresponding target operation, replacing the repetitive and tedious mechanical operation. In this way, the voice commands can transform repetitive manual operation into automated processes, reducing the probability of errors during repetitive manual operation, reducing users' time costs, and reducing user fatigue.

In one embodiment of the present application, the control method based on the multi-direction input device further includes:
obtaining scene feedback information of the terminal device and outputting first voice information according to the scene feedback information.

The terminal device, after establishing a communication connection with the multi-direction input device, can also send the scene feedback information to the multi-direction input device at regular intervals. The scene feedback information can include user state information captured by the terminal device, or the frame rate of the video displayed by the terminal device, or scene information captured by the terminal device.

Exemplarily, the user state information is used to characterize parameters of the user's own state while operating the multi-direction input device. When the user operates a multi-direction input device, the user's own physical state may also affect the operation state, such as when the user is highly concentrated due to prolonged operation. In this way, the user state information can effectively reflect the current operation state of the user.

The terminal device can include a biometric acquisition module for acquiring biometric data of the user. For example, the camera captures the user's eye movement trajectory characteristics, the frequency of facial expression changes, and the duration of body posture. The present application does not limit the specific collection method and content of biometric data. The present application evaluates the user state based on the collected biometric data using a preset evaluation model. In one embodiment, a load evaluation model is obtained, and the evaluation parameters are obtained based on the load evaluation model and the biometric data. When the evaluation parameter is greater than or equal to a first threshold, corresponding user state information is generated to be sent to the multi-direction input device. The multi-direction input device can output corresponding voice information through the voice module after receiving the user state information. For example, when the evaluation parameter is the length of time the user pays attention to the screen, if the evaluation parameter is greater than or equal to the preset first threshold, it indicates that the user pays attention to the screen for a longer period of time, and eye fatigue may exist, and at this time, the multi-direction input device can remind the user to take a rest through the voice information.

The terminal device obtains the frame rate of the displayed video content during operation, and when the frame rate is less than or equal to a first preset frame rate, the terminal device can have insufficient memory, a high temperature of the central processor, or a slow network speed, and at this time, the user sends the corresponding operation command through mechanical operation, and the probability of operation not being in place is increased. Therefore, when the multi-direction input device determines that the frame rate of the received video of the terminal device is less than or equal to the first preset frame rate, the multi-direction input device can output voice information through the voice module to remind the user or assist the user in operation, so as to effectively improve the accuracy of the user's operation. Another example is that when the frame rate is greater than or equal to the second preset frame rate, it indicates that the terminal device is currently displaying a more complex screen content. Therefore, when the multi-direction input device determines that the frame rate of the received video of the terminal device is greater than or equal to a second preset frame rate, the multi-direction input device can output the voice information through the voice module to remind the user or to assist the user in operation or to give an evaluation of the result of the user's operation, so as to enhance the user experience. In other embodiments, the feedback information can also include other operation parameters of the terminal device, such as the frequency of updating dynamic elements of the graphical user interface, the interface picture quality and the packet loss rate, and the present application does not limit the specific concrete content of the feedback information collected by the terminal device during operation.

The terminal device collects scene information during operation, and scene changes have a certain impact on the user's operation. For example, in the virtual scene, when the brightness of the scene exceeds the preset brightness range, resulting in the user difficult to observe the details and changes in the screen in a timely manner, at this time there is a delay in the user's reaction to the situation, through the voice of the user in advance or in a timely manner to interact with the user, such as reminding or guiding the user to operate, etc., so as to facilitate the user to be able to quickly respond to improve the user's use experience. Another example is that when a drone is operated through a multi-direction input device, it is affected by factors such as the flying height of the drone and the external environment, and if the user is unable to pay attention to the flight of the drone in a timely manner during the mechanical operation, it may result in the drone falling, causing the user to incur losses. Therefore, the present application is able to remind the user of the relevant state of the terminal device in real time by outputting voice information, which ensures the stable operation of the terminal device.

In one embodiment of the present application, the control method based on the multi-direction input device further includes steps S201 to S203 as follows.

At step S201, obtaining historical operation trajectory data and real-time operation trajectory data, and outputting voice information.

The historical operation trajectory data includes control commands and corresponding target operation occurring during a first preset time period, and the real-time operation trajectory data includes control commands and corresponding target operation occurring during a second preset time period. The first preset time period occurs before the current moment and the second preset time period includes the current moment.

At step S202, comparing the historical operation trajectory data with the real-time operation trajectory data to obtain a comparison result.

At step S203, outputting second voice information based on the comparison result.

The user may not be able to operate the multi-direction input device properly. By analyzing the historical operation trajectory data and real-time operation trajectory data, it can effectively supplement the deficiencies in user operation and better realize the complex operation to improve the user experience. In one embodiment, a behavior pattern analysis model is obtained. The behavior pattern analysis model is used to mine the user's behavior data, identify the user's operation pattern, and predict the user's operation result. The historical operation data is obtained based on the behavior pattern analysis model, the control commands, the operation function sets, and the user's historical operation trajectory data. The historical operation data is compared with the user's real-time operation trajectory data to determine the user's normal operation. When there is an abnormality in the real-time operation trajectory data, the voice information is outputted. The present application can predict the results of the user's real-time operation based on the user's operation data in the historical data, and when there is a large deviation between the predicted results and the actual results, it indicates that there are deficiencies in the user's operation process, and at this time, the multi-direction input device provides a reminder or guidance to the user through voice. The multi-direction input device can also automatically follow the user's operating habits to supplement the user's insufficient operation. Through personalized judgment of the user's operation trajectory data, it is possible to effectively analyze the effect of the execution of the target operation and reduce the probability of deviation or error due to small errors.

In one embodiment of the present application, the control method based on the multi-direction input device further includes the following steps:
obtaining and saving customized voice commands when the multi-direction input device is in a customized state, and the customized voice commands are interrelated with the preset operation commands.

The customized voice commands are used to perform a target operation corresponding to a preset operation command. The user can customize the voice commands according to their own habits, thus saving time and cost when they need to output many different control commands at the same time. For example, at a certain moment, the user needs to input 5 commonly used voice commands, and these 5 voice commands correspond to a number of operating commands, if the user expresses all the commands completely, even if the user inputs the voice in advance, it will take a lot of time and there is the case of expression error. If the user customizes the associated words for commonly used voice commands in advance when the user is in the custom state, for example, the user pre-set customized voice commands for voice input number 1, and the customized voice commands are associated with a number of operation commands. When the user is in the process of operation, only need to directly say the number 1 to directly retrieve and execute the desired operation commands, this can effectively shorten the voice input time, reduce the probability of inputting the wrong commands.

Please refer to FIG. 4, the present application also provides a multi-direction input device 10, the multi-direction input device 10 includes an operating member 102 and a voice module 106. The operating member 102 is used to generate the operation commands in response to a mechanical operation of a user, and the voice module 106 is used to capture the voice commands and perform a control method based on the multi-direction input device of any of the above embodiments. The voice module 106 can be integrated with the processor 1001, the processor 1001 is used to analyze and process the collected data and the voice module 106 has functions such as voice collection, natural language processing, and dialog management. The voice module 106 can also be provided separately and independently from the processor 1001, and the present application does not limit this. Optionally, the voice module 106 can be a voice processing chip. In some embodiments, the multi-direction input device 10 further includes a memory 1002, the memory 1002 is used to store computer programs and data. The memory 1002 stores instructions executable by the processor 1001, and the instructions are executed by the processor 1001 to perform the control method based on the multi-direction input device described in any of the above embodiments.

The memory 1002 and the processor 1001 are connected by a bus. The bus can include any number of interconnected buses and bridges, and the bus connects one or more processors 1001 and the memory 1002 together. The bus can also connect peripheral devices, voltage regulators and power management circuits, which are well known in the art and will not be described further here. The bus interface provides the interface between the bus and the transceiver. The transceiver can be a single element or a plurality of elements, such as a plurality of receivers and transmitters, providing units for communicating with a variety of other devices on a transmission medium. The data processed by the processor 1001 is transmitted over the wireless medium via the antenna, and further, the antenna also receives the data and transmits the data to the memory 1002. The processor 1001 is responsible for managing the bus and usual processing, and the processor 1001 can also provide a variety of functions including timing, peripheral interfacing, voltage regulation, power management, and other control functions. The memory 1002 can be used to store data used by the processor 1001 in performing operation.

Referring to FIG. 4, the present application also provides a controller 1, the controller 1 includes a multi-direction input device 10 as described in the above embodiment. The controller 1 allows the user to accurately control the target object in three-dimensional space or multiple degrees of freedom through the multi-direction input device 10, and through the input of control commands and signal acquisition from multiple dimensions, it can effectively satisfy the user's need to simultaneously output a variety of complex operations, adapt diversified scenarios, and provide personalized service experience for the user.

Referring to FIG. 4, the present application also provides an information processing system 30, the information processing system 30 includes a terminal device 20 and a multi-direction input device 10 described in the above embodiment, the multi-direction input device 10 can establish a communication connection with the terminal device 20, for example, the multi-direction input device 10 transmits the encrypted control signal to the terminal device 20 through a low-latency communication protocol. The encrypted control signal can be encrypted by Data Encryption Standard (DES) algorithm, Elliptic Curve Cryptography (ECC) algorithm or other encryption algorithms, or the signal can be encrypted by other means, and the present application does not limit the specific implementation of the encrypted control signal.

Those skilled in the art should understand that the above description and the embodiments of the present disclosure shown in the drawings are only examples and do not limit the present disclosure. The purpose of the present disclosure has been completely and effectively achieved. The functions and structural principles of the present disclosure have been shown and explained in the embodiments. Without departing from the principles, the implementation of the present disclosure may have any deformation or modification.

What is claimed is:

1. A control method based on a multi-direction input device, the multi-direction input device establishing a communication connection with a terminal device, the control method comprising:
receiving control commands, the control commands comprising at least one of operation commands obtained in response to a mechanical operation directed to the multi-direction input device and voice commands captured by the multi-direction input device;
generating a control signal based on the control commands and sending the control signal to the terminal device, the control signal configured to control the terminal device to perform target operation, wherein the target operation comprises at least one of the following operations:
a virtual operation in a virtual scene displayed through a graphical user interface provided by the terminal device;
a device control operation on the terminal device; and
an application function operation implemented using the terminal device.

2. The control method according to claim 1, wherein when the control commands comprise the operation commands and the voice commands, the multi-direction input device generates the control signal according to the control commands comprises:
parsing the voice commands to obtain a corresponding command text;
generating a first control signal when the operation commands match a first operation command combination and the command text comprises a first text, wherein the first control signal is configured to control the terminal device to perform the target operation;
when the control commands satisfy a preset condition and there is a conflict between the voice commands and the operation commands, one of the voice commands or the operation commands is prioritized to be executed in accordance with a preset conflict resolution strategy, and the preset condition comprises that the voice commands does not conform to the first operation command combination and/or that the command text does not comprise the first text.

3. The control method according to claim 1, wherein when the control commands comprise the voice commands, the multi-direction input device generates the control signal according to the control commands comprises:
parsing the voice commands to obtain a corresponding command text;
generating a second control signal according to the command text when the command text comprises at least one of a second text or an appointment time; wherein the second control signal is configured to control the terminal device to perform the target operation after the appointment time.

4. The control method according to claim 1, wherein when the control commands comprise the voice commands, the multi-direction input device generates the control signal according to the control commands comprises:
parsing the voice commands to obtain a corresponding command text;
generating a third control signal according to the command text when state feedback information is received from the terminal device and the command text comprises a third text; wherein the third control signal is configured to control the terminal device to perform the target operation, and the state feedback information is configured to indicate that the terminal device is in a configuration state.

5. The control method according to claim 1, further comprising:
obtaining scene feedback information of the terminal device;
outputting first voice information according to the scene feedback information;
wherein the scene feedback information comprises user state information captured by the terminal device, or a frame rate of a video displayed by the terminal device, or scene information captured by the terminal device.

6. The control method according to claim 1, further comprising:
obtaining historical operation trajectory data and real-time operation trajectory data, and outputting voice information, wherein the historical operation trajectory data comprises the control commands and corresponding target operation occurring during a first preset time period, and the real-time operation trajectory data comprises the control commands and corresponding target operation occurring during a second preset time period, the first preset time period occurs before a current moment and the second preset time period comprises the current moment;
comparing the historical operation trajectory data with the real-time operation trajectory data to obtain a comparison result; and
outputting second voice information based on the comparison result.

7. The control method according to claim 1, further comprising:
obtaining and saving customized voice commands when the multi-direction input device is in a customized state; wherein the customized voice commands are interrelated with the preset operation commands, and the customized voice commands are configured to perform a target operation corresponding to a preset operation command.

8. A multi-direction input device comprising an operating member and a voice module, wherein: the operating member is configured to respond to a mechanical operation of a user to generate operation commands, and the voice module is configured to collect voice commands and execute one or more programs stored in a memory, the one or more programs cause the voice module to:
receive control commands, the control commands comprise at least one of operation commands obtained in response to a mechanical operation directed to the multi-direction input device and voice commands captured by the multi-direction input device;
generate a control signal based on the control commands and send the control signal to the terminal device, the control signal is configured to control the terminal device to perform target operation, wherein the target operation comprises at least one of the following operation:
a virtual operation in a virtual scene displayed through a graphical user interface provided by the terminal device;
a device control operation on the terminal device; and
an application function operation implemented using the terminal device.

9. The multi-direction input device of claim 8, wherein when the control commands comprise the operation commands and the voice commands, the voice module is further caused to:
parse the voice commands to obtain a corresponding command text;
generate a first control signal when the operation commands match a first operation command combination and the command text comprises a first text, wherein the first control signal is configured to control the terminal device to perform the target operation;
when the control commands satisfy a preset condition and there is a conflict between the voice commands and the operation commands, one of the voice commands or the operation commands is prioritized to be executed in accordance with a preset conflict resolution strategy, and the preset condition comprises that the voice commands does not conform to the first operation command combination and/or that the command text does not comprise the first text.

10. The multi-direction input device according to claim 8, wherein when the control commands comprise the voice commands, the voice module is further caused to:
parse the voice commands to obtain a corresponding command text;
generate a second control signal according to the command text when the command text comprises at least one of a second text or an appointment time; wherein the second control signal is configured to control the terminal device to perform the target operation after the appointment time.

11. The multi-direction input device according to claim 8, wherein when the control commands comprise the voice commands, the voice module is further caused to:
parse the voice commands to obtain a corresponding command text;
generate a third control signal according to the command text when state feedback information is received from the terminal device and the command text comprises a third text; wherein the third control signal is configured to control the terminal device to perform the target operation, and the state feedback information is configured to indicate that the terminal device is in a configuration state.

12. The multi-direction input device according to claim 8, wherein the voice module is further caused to:
obtain scene feedback information of the terminal device;
output first voice information according to the scene feedback information;
wherein the scene feedback information comprises user state information captured by the terminal device, or a frame rate of a video displayed by the terminal device, or scene information captured by the terminal device.

13. The multi-direction input device according to claim 8, wherein the voice module is further caused to:
obtain historical operation trajectory data and real-time operation trajectory data, and output voice information, wherein the historical operation trajectory data comprises the control commands and corresponding target operation occurring during a first preset time period, and the real-time operation trajectory data comprises the control commands and corresponding target operation occurring during a second preset time period, the first preset time period occurs before a current moment and the second preset time period comprises the current moment;
compare the historical operation trajectory data with the real-time operation trajectory data to obtain a comparison result; and
output second voice information based on the comparison result.

14. The multi-direction input device according to claim 8, wherein the voice module is further caused to:
obtain and saving customized voice commands when the multi-direction input device is in a customized state;
wherein the customized voice commands are interrelated with the preset operation commands, and the customized voice commands are configured to perform a target operation corresponding to a preset operation command.

15. A controller comprising a multi-direction input device as claimed in claim 8.

16. An information processing system comprising a terminal device and a multi-direction input device as claimed in claim 8, wherein the multi-direction input device establishes a communication connection with the terminal device.

17. The information processing system of claim 16, wherein when the control commands comprise the operation commands and the voice commands, the voice module is further caused to:
parse the voice commands to obtain a corresponding command text;
generate a first control signal when the operation commands match a first operation command combination and the command text comprises a first text, wherein the first control signal is configured to control the terminal device to perform the target operation;
when the control commands satisfy a preset condition and there is a conflict between the voice commands and the operation commands, one of the voice commands or the operation commands is prioritized to be executed in accordance with a preset conflict resolution strategy, and the preset condition comprises that the voice commands does not conform to the first operation command combination and/or that the command text does not comprise the first text.

18. The information processing system according to claim 16, wherein when the control commands comprise the voice commands, the voice module is further caused to:
parse the voice commands to obtain a corresponding command text;
generate a second control signal according to the command text when the command text comprises at least one of a second text or an appointment time; wherein the second control signal is configured to control the terminal device to perform the target operation after the appointment time.

19. The information processing system according to claim 16, wherein when the control commands comprise the voice commands, the voice module is further caused to:
parse the voice commands to obtain a corresponding command text;
generate a third control signal according to the command text when state feedback information is received from the terminal device and the command text comprises a third text; wherein the third control signal is configured to control the terminal device to perform the target operation, and the state feedback information is configured to indicate that the terminal device is in a configuration state.

20. The information processing system according to claim 16, wherein the voice module is further caused to:
obtain scene feedback information of the terminal device;
output first voice information according to the scene feedback information;
wherein the scene feedback information comprises user state information captured by the terminal device, or a frame rate of a video displayed by the terminal device, or scene information captured by the terminal device.
